(19) United States
(12) Patent Application Publication
(10) Pub. No.: US 2024/0256899 A1
(43) Pub. Date: Aug. 1, 2024

(54) VERTICAL FEDERATED LEARNING METHOD, APPARATUS, SYSTEM AND DEVICE, AND STORAGE MEDIUM

(71) Applicant: Beijing Bytedance Network Technology Co., Ltd., Beijing (CN)

(72) Inventors: Peixuan HE, Beijing (CN); Yao ZHANG, Beijing (CN); Yang LIU, Beijing (CN); Ye WU, Beijing (CN)

(21) Appl. No.: 18/566,927

(22) PCT Filed: Feb. 22, 2023
(86) PCT No.: PCT/CN2023/077525

§ 371 Date: Dec. 4, 2023

(30) Foreign Application Priority Data
Mar. 15, 2022 (CN) 202210253437.0

(51) Int. Cl. G06N 3/098

(52) U.S. Cl. CPC G06N 3/098

(57) ABSTRACT

The present disclosure provides a vertical federated learning method, apparatus, system, and device, and a storage medium. The method includes: calculating a noise matrix by a first data party based on a mask matrix, determining a product of a residual vector and the noise matrix as a noise-added residual vector, and sending the noise-added residual vector to a second data party; calculating a gradient vector by the second data party based on the noise-added residual vector to update a model parameter.

### CROSS-REFERENCE TO RELATED APPLICATION

The present application claims the priority to Chinese Patent Application No. 202210253437.0, filed on Mar. 15, 2022, entitled “VERTICAL FEDERATED LEARNING METHOD, APPARATUS, SYSTEM AND DEVICE, AND STORAGE MEDIUM,” the entire disclosure of which is incorporated herein by reference as portion of the present application.

### TECHNICAL FIELD

The present disclosure relates to the field of machine learning and, in particular, to a vertical federated learning method, apparatus, system, and device, and a storage medium.

### BACKGROUND

Federated learning is a privacy-preserving distributed machine learning technique for solving the problem of how to jointly train a global model with data from all parties while protecting the security of each data party when private data exists for multiple independent data parties. Federated learning includes horizontal federated learning, vertical federated learning, and federated transfer learning.

Vertical federated learning is to split a data set of each data party vertically (i.e., a feature dimension) and extract data in each data set that has the same sample identifier but not exactly the same feature to jointly train a global model. Vertical federated learning is especially applicable to scenarios where data from multiple parties, such as finance, society, game, and education, serves a tag of one business party. For example, financial lending company C may perform vertical federated learning based on data of social media company A and online education company B as well as its own data and default record tags, to jointly train a global model. The trained global model may be used for financial lending company C to make default predictions, helping financial lending company C to make subsequent decisions based on the prediction results and to reduce the rate of bad debts, and the like.

The data parties participating in vertical federated learning are all intended to share data without exposing their own data, so any sensitive data must be encrypted in order to be output from their own trust domain, and accordingly a homomorphic encryption algorithm is introduced to vertical federated learning. Although homomorphic encryption allows computation on ciphertext, the computational overhead of homomorphic encryption is large, which also affects the performance of machine learning algorithms at the same time, resulting in low efficiency of vertical federated learning. Therefore, how to improve the efficiency of vertical federated learning while ensuring the security of private data of all parties is a technical problem urgent to be solved.

### SUMMARY

In order to solve the above-mentioned technical problem, the embodiments of the present disclosure provide a vertical federated learning method, which can improve the efficiency of vertical federated learning while ensuring the security of privacy data of all parties.

In a first aspect, the present disclosure provides a vertical federated learning method, and the method includes:
receiving a mask matrix corresponding to a third sample set and sent by a second data party in a vertical federated learning system, in which the third sample set is obtained based on splitting a second sample set of the second data party, and a training sample in the second sample set has a corresponding relationship with a training sample with a tag in a local first sample set;
calculating a noise matrix corresponding to the third sample set based on the mask matrix corresponding to the third sample set, in which the noise matrix is composed of a quantity of noise corresponding to each training sample in the third sample set, and the quantity of noise is used for noise addition processing;
determining a residual vector corresponding to the third sample set, and determining a product of the residual vector and the noise matrix corresponding to the third sample set as a noise-added residual vector corresponding to the third sample set, in which the residual vector includes a difference value between a tag value and a current predicted value of a training sample in the third sample set;
and sending the noise-added residual vector corresponding to the third sample set to the second data party, in which the second data party is used to calculate a gradient vector based on the noise-added residual vector, and to update a model parameter corresponding to the second data party based on the gradient vector to obtain an updated model parameter corresponding to the second data party.

In an optional embodiment, calculating a noise matrix corresponding to the third sample set based on the mask matrix corresponding to the third sample set includes:
calculating a product of the mask matrix corresponding to the third sample set and a transposed matrix of the mask matrix;
and determining a difference value between a unit matrix and the product as the noise matrix corresponding to the third sample set.

In an optional embodiment, determining a residual vector corresponding to the third sample set includes:
determining, from the first sample set, a first training sample having a corresponding relationship with a second training sample in the second sample set;
determining a current residual corresponding to the first training sample based on a linear predictor corresponding to the first training sample, a linear predictor corresponding to the second training sample, and a tag value corresponding to the first training sample, in which the linear predictor corresponding to the second training sample is determined by the second data party and sent to a first data party;
determining a residual vector corresponding to the first sample set based on the current residual corresponding to the first training sample;
and determining, from the residual vector corresponding to the first sample set, the residual vector corresponding to the third sample set.

In an optional embodiment, the third sample set is obtained, based on sample identifiers, by splitting the second sample set of the second data party.

In an optional embodiment, the third sample set includes at least one selected from a group consisting of a multimedia data training sample, an audio data training sample, a video data training sample, an image data training sample, and a text data training sample.

In a second aspect, the present disclosure provides a vertical federated learning method, and the method includes:
determining a third sample set based on a local second sample set, and calculating a mask matrix corresponding to the third sample set;
sending the mask matrix corresponding to the third sample set to a first data party in a vertical federated learning system, in which the first data party is used to determine a noise-added residual vector corresponding to the third sample set based on the mask matrix, a first sample set stored in the first data party includes a training sample with a tag, and the training sample with a tag in the first sample set has a corresponding relationship with a training sample in the second sample set;
acquiring the noise-added residual vector from the first data party, and calculating a gradient vector based on the noise-added residual vector;
and updating a local model parameter based on the gradient vector to obtain an updated model parameter.

In an optional embodiment, determining a third sample set based on a local second sample set includes:
splitting the local second sample set based on sample identifiers to obtain the third sample set.

In an optional embodiment, splitting the local second sample set based on sample identifiers to obtain the third sample set includes:
ranking training samples in the local second sample set based on the sample identifiers to obtain a ranked second sample set;
and splitting the ranked second sample set to obtain the third sample set.

In an optional embodiment, calculating a mask matrix corresponding to the third sample set includes:
performing QR decomposition on a matrix corresponding to the third sample set to obtain a Q matrix and an R matrix, in which a product of the Q matrix and the R matrix is the matrix corresponding to the third sample set, and the Q matrix has a same number of rows and columns, which is equal to a total number of rows of the matrix corresponding to the third sample set;
and removing a first m columns of the Q matrix, and acquiring g columns from the Q matrix to form the mask matrix corresponding to the third sample set, in which m is a total number of columns of the matrix corresponding to the third sample set and g is a preset positive integer.

In a third aspect, the present disclosure provides a vertical federated learning system, the vertical federated learning system includes a first data party and at least one second data party, and a training sample with a tag in a first sample set of the first data party has a corresponding relationship with a training sample in a second sample set of the second data party;
the second data party is used to determine a third sample set based on the second sample set, calculate a mask matrix corresponding to the third sample set, and send the mask matrix corresponding to the third sample set to the first data party;
the first data party is used to calculate a noise matrix corresponding to the third sample set based on the mask matrix corresponding to the third sample set, determine a residual vector corresponding to the third sample set, determine a product of the residual vector and the noise matrix corresponding to the third sample set as a noise-added residual vector corresponding to the third sample set, and send the noise-added residual vector corresponding to the third sample set to the second data party, in which the noise matrix is composed of a quantity of noise corresponding to each training sample in the third sample set, the quantity of noise is used for noise addition processing, the residual vector includes a difference value between a tag value and a current predicted value of a training sample in the third sample set;
and the second data party is further used to calculate a gradient vector based on the noise-added residual vector, and to update a local model parameter based on the gradient vector to obtain an updated model parameter corresponding to the second data party.

In a fourth aspect, the present disclosure provides a vertical federated learning apparatus, and the apparatus includes:
a first receiving module, configured to receive a mask matrix corresponding to a third sample set and sent by a second data party in a vertical federated learning system, in which the third sample set is obtained based on splitting a second sample set of the second data party, and a training sample in the second sample set has a corresponding relationship with a training sample with a tag in a local first sample set;
a first calculation module, configured to calculate a noise matrix corresponding to the third sample set based on the mask matrix corresponding to the third sample set, in which the noise matrix is composed of a quantity of noise corresponding to each training sample in the third sample set, and the quantity of noise is used for noise addition processing;
a first determination module, configured to determine a residual vector corresponding to the third sample set, and determine a product of the residual vector and the noise matrix corresponding to the third sample set as a noise-added residual vector corresponding to the third sample set, in which the residual vector includes a difference value between a tag value and a current predicted value of a training sample in the third sample set;
and a first sending module, configured to send the noise-added residual vector corresponding to the third sample set to the second data party, in which the second data party is used to calculate a gradient vector based on the noise-added residual vector, and to update a model parameter corresponding to the second data party based on the gradient vector to obtain an updated model parameter corresponding to the second data party.

In a fifth aspect, the present disclosure provides a vertical federated learning apparatus, and the apparatus includes:
a second determination module, configured to determine a third sample set based on a local second sample set;
a second calculation module, configured to calculate a mask matrix corresponding to the third sample set;
a second sending module, configured to send the mask matrix corresponding to the third sample set to a first data party in a vertical federated learning system, in which the first data party is used to determine a noise-added residual vector corresponding to the third sample set based on the mask matrix, a first sample set stored in the first data party includes a training sample with a tag, and the training sample with a tag in the first sample set has a corresponding relationship with a training sample in the second sample set;
a third calculation module, configured to acquire the noise-added residual vector from the first data party, and calculate a gradient vector based on the noise-added residual vector;
and an update module, configured to update a local model parameter based on the gradient vector to obtain an updated model parameter.

In a sixth aspect, the present disclosure provides a computer-readable storage medium, storing instructions, and the instructions, when run on a terminal device, cause the terminal device to implement the above-mentioned methods.

In a seventh aspect, the present disclosure provides a vertical federated learning device, including a memory, a processor, and a computer program stored on the memory and runnable on the processor, and the processor, when executing the computer program, implements the above-mentioned methods.

In an eighth aspect, the present disclosure provides a computer program product, including a computer program/instruction, and the computer program/instruction, when executed by a processor, implements the above-mentioned methods.

Technical solutions provided in the embodiments of the present disclosure have the following advantages compared with the prior art.

The embodiments of the present disclosure provide a vertical federated learning method, which is applied to a vertical federated learning system. After receiving the mask matrix corresponding to the third sample set sent by the second data party, the first data party calculates the noise matrix corresponding to the third sample set based on the mask matrix, and after determining the residual vector corresponding to the third sample set, determine the product of the residual vector and the corresponding noise matrix as the noise-added residual vector. After the first data party sends the noise-added residual vector corresponding to the third sample set to the second data party, the second data party calculates the gradient vector based on the noise-added residual vector for updating the model parameter. In the embodiments of the present disclosure, the first data party calculates the noise matrix for the second data party and encrypts the residual vector based on the noise matrix to ensure that the residual vector calculated by the first data party will not be acquired by the second data party, thus achieving the purpose of protecting the privacy of tags in samples of the first data party. In addition, compared to the homomorphic encryption technique, the way of encrypting the residual vector by the noise matrix has less computational overhead, and thus the embodiments of the present disclosure are able to improve the efficiency of vertical federated learning while ensuring data privacy.

### BRIEF DESCRIPTION OF DRAWINGS

The drawings herein are incorporated into and form a part of the specification, illustrate the embodiments consistent with the present disclosure, and are used in conjunction with the specification to explain the principles of the present disclosure.

In order to more clearly illustrate the technical solutions in the embodiments of the present disclosure or in prior art, the drawings to be used in the description of the embodiments or prior art will be briefly described below, and it will be obvious to those ordinarily skilled in the art that other drawings can be obtained on the basis of these drawings without inventive work.

FIG. 1 is a schematic diagram of a structure of a vertical federated learning system according to an embodiment of the present disclosure;

FIG. 2 is a flowchart of a vertical federated learning method according to an embodiment of the present disclosure;

FIG. 3 is a flowchart of another vertical federated learning method according to an embodiment of the present disclosure;

FIG. 4 is a schematic diagram of a structure of a vertical federated learning apparatus according to an embodiment of the present disclosure;

FIG. 5 is a schematic diagram of a structure of another vertical federated learning apparatus according to an embodiment of the present disclosure; and

FIG. 6 is schematic diagram of a structure of a vertical federated learning device according to an embodiment of the present disclosure.

### DETAILED DESCRIPTION

In order to understand the above objects, features and advantages of the present disclosure more clearly, the solutions of the present disclosure will be further described below. It should be noted that, in case of no conflict, the features in one embodiment or in different embodiments can be combined.

Many specific details are set forth in the following description to fully understand the present disclosure, but the present disclosure can also be implemented in other ways different from those described here; obviously, the embodiments in the specification are a part but not all of the embodiments of the present disclosure.

Federated learning refers to the establishment of a virtual shared model with federated data from multiple participants on the premise that data of all parties are kept locally without privacy disclosure. Specifically, federated learning may establish a virtual shared model without privacy disclosure in a way of parameter exchange under an encryption mechanism while retaining the data of all parties locally. Federated learning, as a modeling method to guarantee data security, has a great application prospect in various fields.

Vertical federation learning belongs to one of various types of federation learning. To facilitate the understanding of vertical federation learning, the present disclosure describes the following scenario as an example of an application scenario of vertical federation learning.

Assuming that participants of vertical federal learning, A, B, and C, are three companies respectively, where A is a social media company and B is an online education company, A owns a large number of social-related features of a large number of people, as shown in Table 1 below; whereas B owns education-related features of this group of people, as shown in Table 2 below; and C is a financial lending company, which owns credit records of this group of people and a small number of related features, as shown in Table 3.

TABLE 1
Social media company A

| | Feature: Login | Feature: Browsing | Feature: Topics |
|---|---|---|---|
| User ID | frequency | time | of interest |
| 1 | XXX | XXX | XXX |
| 2 | XXX | XXX | XXX |
| 3 | XXX | XXX | XXX |

TABLE 2
Network education company B

| | Feature: Educational | Feature: Course | Feature: Online |
|---|---|---|---|
| User ID | background | purchase | frequency |
| 1 | XXX | XXX | XXX |
| 2 | XXX | XXX | XXX |
| 3 | XXX | XXX | XXX |

TABLE 3
Financial lending company C

| | Tag: Default | Feature: Credit | Feature: Login |
|---|---|---|---|
| User ID | record | inquiry frequency | frequency |
| 1 | XXX | XXX | XXX |
| 2 | XXX | XXX | XXX |
| 3 | XXX | XXX | XXX |

Assuming that financial lending company C wants to perform vertical federated learning based on data of social media company A and online education company B as well as its own data and default record tags to jointly train a shared model, then it needs to protect the privacy of data of each party (including features and tags) from being disclosed to the other party and the third party during a model training process. After the model training is completed, the trained model may be used to predict defaults, which helps financial lending company C to make subsequent decisions based on prediction results and to reduce the rate of bad debts, and the like.

At present, the above-mentioned application scenario of vertical federated learning is based on homomorphic encryption technology to ensure that the privacy data of all parties in the model training process is not leaked to the other party and the third party. However, the computational overhead of homomorphic encryption is large, and vertical federated learning often requires multiple trainings to obtain a better model, which makes the defect of large overhead of homomorphic encryption even more obvious, thus resulting in lower efficiency of model training through vertical federated learning.

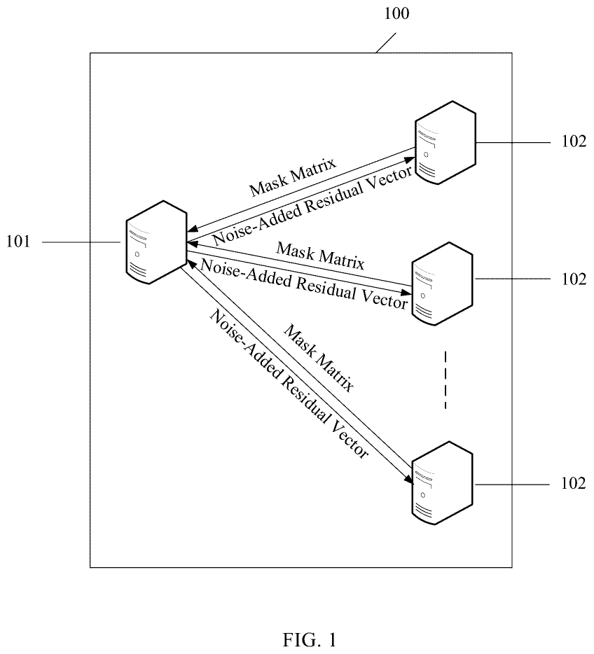

Therefore, the embodiments of the present disclosure provide a vertical federated learning system. FIG. 1 shows a schematic diagram of a structure of a vertical federated learning system according to an embodiment of the present disclosure, in which the vertical federated learning system 100 includes a first data party 101 and at least one second data party 102.

Specifically, a local first sample set of the first data party 101 includes a training sample with a tag, a training sample included in a local second sample set of the second data party 102 has a corresponding relationship with the training sample with the tag in the first sample set, and the training sample in the second sample set does not has a tag.

In an optional embodiment, before the vertical federated learning, an intersection of sample sets from the first data party and each second data party is first determined. The intersection may include training samples having the same sample identifier in the sample sets of respective data parties. Tables 1, 2, and 3 above show the training samples having the same user ID in the sample sets of the data parties, i.e., the intersection of the sample sets, respectively. It is possible to describe features of the training samples having the same user ID in terms of different feature dimensions by combining Tables 1, 2 and 3.

In addition, manners used to determine the intersection of the sample sets of the data parties are not limited in the embodiments of the present disclosure.

Specifically, the second data party 102 is used to determine a third sample set based on the second sample set, calculate a mask matrix corresponding to the third sample set, and send the mask matrix corresponding to the third sample set to the first data party.

The way of processing the second sample set directly requires a large amount of memory, which may be prone to runtime errors, so the second data party in the embodiments of the present disclosure may pre-divide the training samples in the second sample set into at least one third sample set based on the number of the training samples in the second sample set.

In an optional embodiment, the training samples in the second sample set may be ranked based on sample identifiers, and the ranked training samples may be divided into at least one third sample set, each third sample set includes a specific number of training samples.

It should be noted that when the magnitude of the training samples in the second sample set is small, the second sample set may be processed directly, that is, the second sample set is divided into one third sample set corresponding to the second data party.

The first data party 101 is used to calculate a noise matrix corresponding to the third sample set based on the mask matrix corresponding to the third sample set, determine a residual vector corresponding to the third sample set, determine the product of the residual vector and the noise matrix corresponding to the third sample set as a noise-added residual vector corresponding to the third sample set, and send the noise-added residual vector corresponding to the third sample set to the second data party. Herein, the noise matrix is composed of the quantity of noise corresponding to each training sample in the third sample set, the quantity of noise is used for noise addition processing, and the residual vector includes a difference value between a tag value and a current predicted value of the training sample in the third sample set.

In an optional embodiment, after calculating a mask matrix for each third sample set in the second sample set, the second data party sends each mask matrix to the first data party, in which each mask matrix carries a sample identifier for each training sample in the corresponding third sample set, so that the first data party is capable of determining the sample identifier corresponding to that mask matrix. The sample identifiers are used to identify the training samples, such as the user IDs in Tables 1, 2, and 3 above, respectively.

The first data party calculates a noise matrix for each third sample set based on the mask matrix, and in every model training, the product obtained by multiplying the noise matrix of each third sample set with its corresponding residual vector is determined as a noise-added residual vector of the corresponding third sample set. Then, the noise-added residual vector is sent by the first data party to the corresponding second data party. Because the noise-added residual vector is encrypted based on the noise matrix, residuals calculated by the first data party will not be leaked during transmission of the noise-added residual vector in every model training, and the privacy and security of sample tags of the first data party are protected.

The second data party 102 is further used to calculate a gradient vector based on the noise-added residual vector, and to update a model parameter corresponding to the second data party based on the gradient vector to obtain an updated model parameter corresponding to the second data party.

In practical applications, after obtaining the updated model parameter in every model training, the second data party needs to determine whether a preset training stop condition is satisfied currently, and obtains the updated model parameter corresponding to the second data party after determining that the preset training stop condition is satisfied, otherwise, continues to iterate the training.

In practice applications, after receiving the noise-added residual vector, the second data party calculates the gradient vector based on the noise-added residual vector, and the calculated gradient vector is used to update the model parameter of the second data party. Herein, the model parameter includes a weight corresponding to a feature of each dimension in the local second sample set of the second data party, such as the weight corresponding to the features “login frequency”, “browsing time”, and “topics of interest” in Table 1 above, respectively.

At the end of every model training, it is determined whether the preset training stop condition is satisfied currently, and if not, the next model training is continued until the preset training stop condition is satisfied. If the preset training stop condition is satisfied currently, the updated model parameter corresponding to the second data party may be acquired for use in forming a model trained by the vertical federated learning system 100.

The first data party 101 is further used to determine a residual vector corresponding to the first sample set, calculate a gradient vector based on the residual vector, update a model parameter corresponding to the first data party based on the gradient vector, and acquire an updated model parameter corresponding to the first data party after determining that the preset training stop condition is satisfied, otherwise, iterate the training. The updated model parameters corresponding to the first data party and the second data party respectively are used to form the model obtained based on the training of the vertical federated learning system.

In practical applications, in every model training, the first data party updates the model parameter by calculating the residual vector and gradient vector, and stops the model training after it is determined that the preset training stop condition is satisfied, to acquire the updated model parameter of the first data party that is used in forming the model trained by the vertical federated learning system 100.

In the model training process using the vertical federated learning system, each data party trains its corresponding model parameter. After the end of the training, the respective updated model parameters corresponding to the data parties respectively are federated to form a successfully trained model, i.e., a global model, which is also referred to as a shared model. In other words, the model obtained by vertical federated learning is obtained by jointly training the data from multiple parties.

In the vertical federated learning system provided by the embodiments of the present disclosure, the first data party calculates the noise matrix for the second data party and encrypts the residual vector based on the noise matrix to ensure that the residual vector calculated by the first data party will not be acquired by the second data party, thus achieving the purpose of protecting the privacy of tags in samples of the first data party. In addition, compared to the homomorphic encryption technique, the way of encrypting the residual vector by the noise matrix has less computational overhead, and thus the embodiments of the present disclosure are able to improve the efficiency of vertical federated learning while ensuring data privacy.

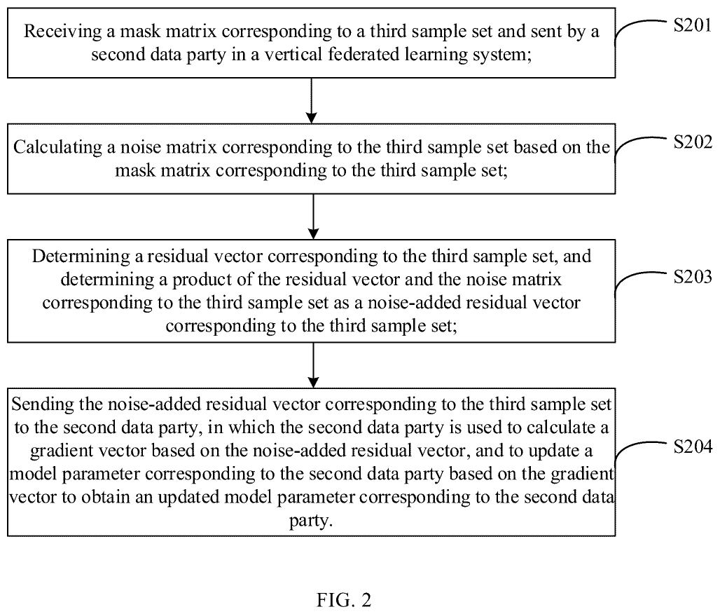

Based on the above-mentioned vertical federated learning system, the embodiments of the present disclosure provide a vertical federated learning method. FIG. 2 shows a flowchart of a vertical federated learning method according to an embodiment of the present disclosure.

The method is applied to the first data party in the vertical federated learning system. The vertical federated learning system further includes at least one second data party, and a training sample with a tag in a first sample set of the first data party has a corresponding relationship with a training sample in a second sample set of the second data party. Specifically, the method includes the following steps.

S201: receiving a mask matrix corresponding to a third sample set and sent by a second data party in a vertical federated learning system.

The third sample set is obtained based on splitting a second sample set of the second data party, and a training sample in the second sample set has a corresponding relationship with a training sample with a tag in a local first sample set.

The first sample set, the second sample set, and the third sample set each may include training samples of various data types, for example, the third sample set may include at least one selected from a group consisting of a multimedia data training sample, an audio data training sample, a video data training sample, an image data training sample, and a text data training sample.

In the embodiments of the present disclosure, the first data party receives a mask matrix from at least one second data party. The mask matrix is obtained by the corresponding second data party calculating the training samples in the third sample set split from the local second sample set, and the specific calculations are described in subsequent embodiments.

For ease of description, in the embodiments of the present disclosure, it is assumed that training samples in the local first sample set of the first data party include x₁∈R^{l×m}^{₁}, γ∈{0,1}^{l}, where the first sample set includes l training samples, each training sample has eigenvalues of m₁ dimensions, γ∈ {0,1}^{l} is used to represent the column where a tag of a training sample is located, and each training sample has a tag of 0 or 1. Training samples in the local second sample set of the second data party include x₂∈R^{l×m}^{₂}. The training samples in the first sample set and the second sample set are obtained after an intersection calculation of the local data of the first data party and the second data party, and the training samples in the first sample set and the second sample set have a corresponding relationship with each other, for example, the training samples in the first sample set and the second sample set have sample identifiers corresponding to each other. As shown in Tables 1 and 3 above, both the first sample set and the second sample set include training samples with user IDs of 1, 2, and 3, respectively.

Due to the large amount of data in the second sample set, in order to reduce the probability of runtime errors in system operation, the second data party may pre-divide the training samples in the local second sample set into different third sample sets. For example, x₂∈R^{l×m}^{₂} is split into a plurality of x_{2,i}∈R^{l′×m}^{₂}, where l′<<l.

In an optional embodiment, the training samples in the second sample set may be ranked according to a preset strategy, and the ranked training samples may be divided into different third sample sets. Specifically, the training samples in the second sample set may be ranked in an order of the sample identifiers from small to large, and the ranked training samples may be divided into different third sample sets.

S202: calculating a noise matrix corresponding to the third sample set based on the mask matrix corresponding to the third sample set.

The noise matrix is composed of the quantity of noise corresponding to each training sample in the third sample set, and the quantity of noise is used for noise addition processing.

In the embodiments of the present disclosure, the first data party, after receiving the mask matrix, forms the noise matrix based on the mask matrix.

In an optional embodiment, the first data party, after receiving the mask matrix, determines a transpose matrix of the mask matrix, calculates the matrix product of the transpose matrix and the mask matrix, and then determines a difference value between a unit matrix and the matrix product as the noise matrix of the third sample set corresponding to the mask matrix.

Specifically, the noise matrix may be calculated by formula (1) as follows:

$${C}_{i} = I - {Z}_{i} {Z}_{i}^{T} ; \qquad ( 1 )$$

where Cᵢ is used to represent the noise matrix of an i-th third sample set, Zᵢ is used to represent the mask matrix corresponding to the third sample set, Zᵢ^{T} is used to represent the transpose matrix of the mask matrix Zᵢ, and I is used to represent the unit matrix, i.e., a matrix in which elements on the diagonal are 1 and other elements are 0.

It should be noted that the mask matrix received by the first data party has a corresponding relationship with the third sample set of the second data party, and therefore the noise matrix calculated based on the mask matrix also has a corresponding relationship with the third sample set corresponding to the mask matrix, i.e., is the noise matrix of the third sample set.
S203: determining a residual vector corresponding to the third sample set, and determining a product of the residual vector and the noise matrix corresponding to the third sample set as a noise-added residual vector corresponding to the third sample set.

The residual vector includes a difference value between a tag value and a current predicted value of a training sample in the third sample set.

In every model training based on vertical federated learning, the first data party is required to determine the current residual corresponding to each training sample to indicate the difference between the current predicted value and the true tag value.

In an optional embodiment, the first data party first determines, from the first sample set, a first training sample having a corresponding relationship with a second training sample in the second sample set; determines a current residual corresponding to the first training sample based on a linear predictor corresponding to the first training sample, a linear predictor corresponding to the second training sample, and a tag value corresponding to the first training sample, in which the linear predictor corresponding to the second training sample is determined by the second data party and sent to the first data party; then determines a residual vector corresponding to the first sample set based on the current residual corresponding to the first training sample; and finally determines, from the residual vector corresponding to the first sample set, the residual vector corresponding to the third sample set.

In practical applications, model parameter initialization is performed before model training, and model parameters include weight values corresponding to features of various dimensions of the training sample, respectively. It is assumed that the weight values corresponding to the features of various dimensions of the training sample in the local first sample set of the first data party respectively form a weight vector w₁∈R^{m}^{₁}, and m₁ is used to represent the number of feature dimensions. It is assumed that each training sample in the first sample set is x, the first data party independently calculates a linear predictor w₁^{T}x corresponding to each training sample X in the first sample set.

It is assumed that weight values corresponding to features of various dimensions of the training sample in the local second sample set of the second data party form a weight vector w₂∈R^{m}^{₂}, and m₂ is used to represent the number of feature dimensions. It is assumed that each training sample in the second sample set is x, the second data party independently calculates a linear predictor w₂^{T}x corresponding to each training sample X in the second sample set.

The second data party sends the linear predictor w₂^{T}x to the first data party after independently calculating to obtain a feature value for each training sample. Based on sample identifiers, it can be determined that for the same training sample x, the linear predictor obtained by jointly calculating the local data of the data parties is w₁^{T}x+w₂^{T}x.

It should be noted that if the vertical federated learning system includes a plurality of second data parties, for the training sample having the same sample identifier, it is necessary to federate the local data of the first data party and the plurality of second data parties to calculate the linear predictor corresponding to the training sample.

After the first data party calculates to obtain the linear predictor for the training sample x, the first data party calculates the overall linear predictor lₓ=w₁^{T}x+w₂^{T}x for the training sample x by combining the linear predictors independently calculated from respective second data parties, and determines the current predicted value of the training sample x based on the linear predictor. Assuming the currently trained model is a logistic regression model, the current predicted value of the training sample x is

$${\hat{y}}_{x} = \frac{1}{1 + exp ( - {l}_{X} )} .$$

Then the difference value rₓ=yₓ−ŷₓ between the current predicted value ŷₓ of the training sample x and the true tag value yₓ of that training sample x is determined as the current residual of the training sample X.

Alternatively, the currently trained model may be another type of model, such as a linear regression model, then the current predicted value of the training sample x may be ŷₓ=lₓ. Other types of models are not exemplified one by one in the embodiments of the present disclosure.

After the first data party determines the current residual of each training sample in accordance with the above method, the current residuals of respective training samples are formed into the residual vector Y=[r₁, . . . , rₙ]^{T}.

In order to ensure the security of private data, the first data party cannot send a residual in plaintext to the second data party, so that in the embodiments of the present disclosure, the noise vector may be used to encrypt the residual and send it to the second data party to ensure the security of private data.

In the embodiments of the present disclosure, based on the strategy that the second data party splits the second sample set into a plurality of third sample sets, the first data party splits the residual vector Y=[r₁, . . . , rₙ]^{T} into residual vectors Yᵢ∈R^{l′×1} corresponding to respective third sample sets, where l′ is the number of training samples contained in the third sample set.

In an optional embodiment, the strategy of splitting the second sample set into a plurality of third sample sets may refer to ranking the training samples in the second sample set in an order of the sample intensifiers from small to large and dividing the ranked training samples into different third sample sets. Accordingly, the first data party also ranks the current residuals of the training samples among the residual vectors in an order of the sample identifiers from small to large, and forms a residual vector corresponding to each third sample set based on the current residuals of the ranked training samples. Each residual vector has a corresponding third sample set, and a training sample in this third sample set has a corresponding relationship with a training sample corresponding to the current residual in the corresponding residual vector, for example, the sample identifiers have a corresponding relationship with each other.

In the embodiments of the present disclosure, after the residual vector corresponding to each third sample set is determined, the residual vector is encrypted using its corresponding noise matrix. Specifically, the first data party multiplies the residual vector and the noise matrix corresponding to the same third sample set to obtain the product that is used as a noise-added residual vector corresponding to the third sample set. The noise-added residual vector may be calculated by formula (2) as follows:

$${D}_{i} = {C}_{i} {Y}_{i} \qquad ( 2 )$$

where Cᵢ is used to represent the noise matrix of an i-th third sample set, Yᵢ is used to represent the residual vector corresponding to the i-th third sample set, and Dᵢ is used to represent the noise-added residual vector corresponding to the i-th third sample set.
S204: sending the noise-added residual vector corresponding to the third sample set to the second data party.

The second data party is used to calculate a gradient vector based on the noise-added residual vector, and to update a model parameter corresponding to the second data party based on the gradient vector to obtain an updated model parameter corresponding to the second data party.

In the embodiments of the present disclosure, the first data party, after calculating the noise-added residual vector corresponding to each third sample set, sends the noise-added residual vector to the corresponding second data party. The second data party calculates the gradient vector based on the noise-added residual vector, and updates the model parameter corresponding to the second data party based on the gradient vector. The specific implementation is described in subsequent embodiments.

In practical applications, the first data party may determine the residual vector corresponding to the local first sample set, calculate the gradient vector based on the residual vector, and update the model parameter corresponding to the first data party based on the gradient vector to obtain the updated model parameter corresponding to the first data party.

The first data party, after determining the residual vector Y=[r₁, . . . , rₙ]^{T} corresponding to the first sample set, calculates the gradient vector based on the residual vector. Specifically, the gradient vector may be calculated by formula (3) as below:

$${G}_{1} = \frac{1}{l} {x}_{1}^{T} Y ; \qquad ( 3 )$$

where x₁ is used to represent a training sample in the first sample set, l is used to represent the number of training samples in the first sample set, and G₁ is used to represent the gradient vector corresponding to the first sample set.

Because the residual vector Y=[r₁, . . . , rₙ]^{T} is obtained by calculation based on the training samples of respective data parties, the first data party calculates the gradient vector G₁ based on the residual vector and updates the model parameter of the first data party based on the gradient vector, thereby achieving the purpose of jointly training the model with the data from multiple parties based on the training samples of respective data parties.

In the embodiments of the present disclosure, after calculating to obtain the gradient vector, the first data party updates its corresponding model parameter based on the gradient vector to obtain its corresponding updated model parameter. It is assumed that the updated model parameter corresponding to the first data party is w₁-ηG₁, where w₁ is a model parameter before being updated, G₁ represents the gradient vector calculated by the first data party in the current model training, and η is a preset value.

The first data party, after determining that the preset training stop condition is satisfied, may acquire its corresponding updated model parameter, otherwise, continue to execute step S203 and iterate the training.

The updated model parameter is used to form the model obtained based on the training of the vertical federated learning system.

In the embodiments of the present disclosure, the preset training stop condition may be set based on the number of training times, for example, when the number of training times reaches n, then the training of the model is stopped. The preset training stop condition may also be set based on a difference value between the updated model parameters obtained from two adjacent trainings, for example, when the difference value between the updated model parameters obtained from two adjacent trainings is less than a preset threshold, then the training of the model is stopped.

It should be noted that in the embodiments of the present disclosure, the training stop condition may be set according to demands, and there is no limitation thereon.

In practical applications, after it is determined that the preset training stop condition is not satisfied currently, the model training is started for a new round. Specifically, residual vectors corresponding to third sample sets in a new model training are re-determined until it is determined that the preset training stop condition is satisfied. At this point, the updated model parameter obtained by the first data party from the most recent model training may be acquired, and the updated model parameter may be used to form the model obtained based on the training of the vertical federated learning system.

In the vertical federated learning method provided by the embodiments of the present disclosure, the first data party calculates the noise matrix for the second data party and encrypts the residual vector based on the noise matrix to ensure that the residual vector calculated by the first data party will not be acquired by the second data party, thus achieving the purpose of protecting the privacy of tags in samples of the first data party. In addition, compared to the homomorphic encryption technique, the way of encrypting the residual vector by the noise matrix has less computational overhead, and thus the embodiments of the present disclosure are able to improve the efficiency of vertical federated learning while ensuring data privacy.

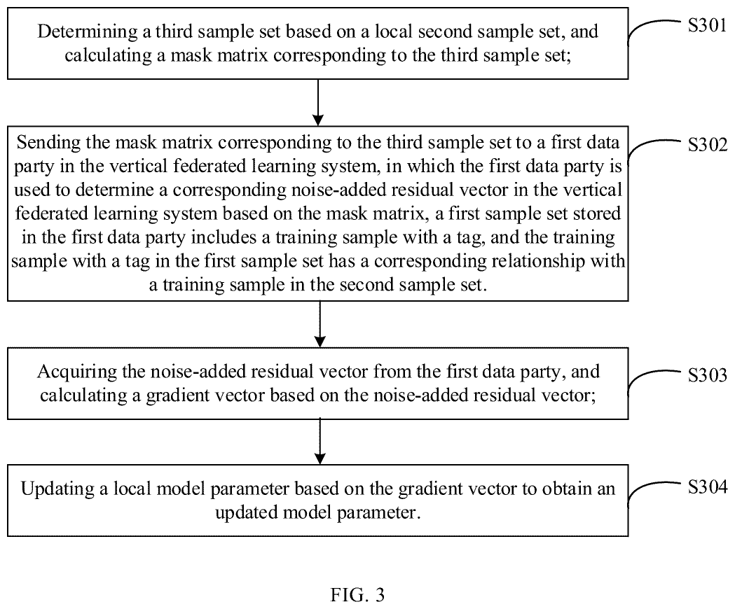

Based on the above-mentioned embodiments, the embodiments of the present disclosure further provide a vertical federated learning method. FIG. 3 shows a flowchart of another vertical federated learning method according to an embodiment of the present disclosure.

For example, the method is applied to the second data party in the vertical federated learning system, and the second data party stores a second sample set. Specifically, the method includes the following steps.
S301: determining a third sample set based on a local second sample set, and calculating a mask matrix corresponding to the third sample set.

In an optional embodiment, the second data party may split the local second sample set based on sample identifiers to obtain the third sample set.

In an optional embodiment, the second data party ranks the training samples in the second sample set in an order of sample identifiers from small to large, and divides the ranked training samples into different third sample sets.

In an optional embodiment, the second data party first performs QR decomposition on a matrix corresponding to the third sample set to obtain a Q matrix and an R matrix, in which the product of the Q matrix and the R matrix is the matrix corresponding to the third sample set, and the Q matrix has the same number of rows and columns, which is equal to the number of rows of the matrix corresponding to the third sample set. After that, the first m columns of the Q matrix are removed, g columns are acquired from the Q matrix to form the mask matrix corresponding to the third sample set, where m is the number of columns of the matrix corresponding to the third sample set and g is a preset positive integer.

It should be noted that the specific implementation of the QR decomposition is not repeated in the embodiments of the present disclosure, and the Q matrix for forming the mask matrix can be obtained by performing the QR decomposition on the matrix.

The following is an example of the second data party splitting x₂∈R^{l×m}^{₂} into a plurality of x_{2,i}∈R^{l′×m}^{₂}. The first data party calculates a mask matrix for the matrix x_{2,i}∈R^{l′×m}^{₂} corresponding to each third sample set.

In practical applications, the QR decomposition is performed for the matrix of each third sample set, i.e., finding Qᵢ∈R^{l×l} and Rᵢ∈R^{l′×m}^{₂} that satisfy the condition such that x_{2,i}=QᵢRᵢ. Then, the first m₂ columns of the matrix Qᵢ are removed to obtain Q′ᵢ∈R^{l×(l′-m}^{₂}⁾, and g columns in Q′ᵢ∈R^{l×(l′-m}^{₂}⁾ are selected to form the mask matrix Zᵢ∈R^{l′×g}, where m₂ is used to represent the number of feature dimensions of the training samples in the local second sample set of the second data party. As shown in Table 1 above, the number of the corresponding feature dimensions is 3, i.e., it contains three feature dimensions of “login frequency”, “browsing time” and “topics of interest”, and the value of m₂ is 3. In addition, in an optional embodiment, g=(m₂/(m₂+1))*l′.
S302: sending the mask matrix corresponding to the third sample set to a first data party in the vertical federated learning system.

The first data party is used to determine a corresponding noise-added residual vector in the vertical federated learning system based on the mask matrix, a first sample set stored in the first data party includes a training sample with a tag, and the training sample with a tag in the first sample set has a corresponding relationship with a training sample in the second sample set.

In the embodiments of the present disclosure, the second data party calculates to obtain the mask matrix Zᵢ corresponding to each third sample set and then sends Zᵢ to the first data party.

It should be noted that, the process that the first data party determines a noise-added residual vector corresponding to each third sample set based on the mask matrix Zᵢ and trains the local model parameter may be understood with reference to the foregoing embodiments, and will not be repeated herein.
S303: acquiring the noise-added residual vector from the first data party, and calculating a gradient vector based on the noise-added residual vector.

In the embodiments of the present disclosure, the second data party, after receiving the noise-added residual vector from the first data party, may calculate the gradient vector based on each noise-added residual vector.

In practical applications, the second data party may calculate the gradient vector by formula (4), specifically:

$${G}_{2} = \frac{1}{l} \sum {x}_{2 , i}^{T} {D}_{i} \qquad ( 4 )$$

where Dᵢ is used to represent the noise-added residual vector corresponding to the i-th third sample set, x_{2,i}^{T} is used to represent a training sample in the i-th third sample set, l is used to represent the number of training samples in the second sample set, i.e., the total number of training samples in all the third sample sets; and G₂ is used to represent the gradient vector calculated by the second data party in the current model training.

In the embodiments of the present disclosure, because the residual vector received by the second data party is a noise-added residual matrix encrypted based on the noise matrix, the second data party is unable to acquire the plaintext of the residual vector calculated by the first data party, thereby ensuring the security of private data of the first data party. In addition, the noise-added residual matrix can be used for calculation of the gradient vector, without affecting the training of the model parameter by the second data party.

In addition, in the embodiments of the present disclosure, the gradient vector is calculated based on the noise-added residual matrix, which does not consume much of the system performance, and can improve the efficiency of model training while ensuring the security of private data.
S304: updating a local model parameter based on the gradient vector to obtain an updated model parameter.

In the embodiments of the present disclosure, after the second data party calculates to obtain the gradient vector, the second data party updates its corresponding model parameter based on the gradient vector to obtain its corresponding updated model parameter. It is assumed that the updated model parameter corresponding to the second data party is w₂-ηG₂, where w₂ is the model parameter before being updated, G₂ represents the gradient vector calculated by the second data party in the current model training, and η is a preset value.

The second data party obtains its corresponding updated post model parameter after determining that the preset training stop condition is satisfied, otherwise, continues to perform the step of obtaining the noise-added residual vector from the first data party and iterates the training.

The updated model parameter is used to form the model obtained based on the training of the vertical federated learning system.

The preset training stop condition in the embodiments of the present disclosure may be understood with reference to the foregoing embodiments. In an optional embodiment, the preset training stop condition may refer to that the model training of the first data party reaches N rounds and the model training of the at least one second data party reaches N rounds.

In the vertical federated learning method provided by the embodiments of the present disclosure, the second data party calculates the gradient vector based on the residual vector after noise addition from the noise matrix, which consumes less system resources, and can improve the efficiency of vertical federated learning while ensuring data privacy.

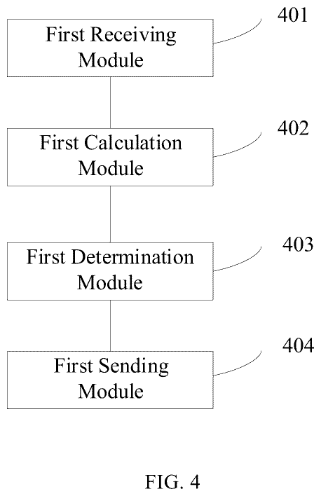

Based on the above-mentioned embodiments, the present disclosure further provides a vertical federated learning apparatus. With reference to FIG. 4, which shows a schematic diagram of a structure of a vertical federated learning apparatus according to an embodiment of the present disclosure, the apparatus includes:
a first receiving module 401, configured to receive a mask matrix corresponding to a third sample set and sent by a second data party in a vertical federated learning system, in which the third sample set is obtained based on splitting a second sample set of the second data party, and a training sample in the second sample set has a corresponding relationship with a training sample with a tag in a local first sample set;
a first calculation module 402, configured to calculate a noise matrix corresponding to the third sample set based on the mask matrix corresponding to the third sample set, in which the noise matrix is composed of the quantity of noise corresponding to each training sample in the third sample set, and the quantity of noise is used for noise addition processing;
a first determination module 403, configured to determine a residual vector corresponding to the third sample set, and determine the product of the residual vector and the noise matrix corresponding to the third sample set as a noise-added residual vector corresponding to the third sample set, in which the residual vector includes a difference value between a tag value and a current predicted value of a training sample in the third sample set;
and a first sending module 404, configured to send the noise-added residual vector corresponding to the third sample set to the second data party, in which the second data party is used to calculate a gradient vector based on the noise-added residual vector, and to update a model parameter corresponding to the second data party based on the gradient vector to obtain an updated model parameter corresponding to the second data party.

In an optional embodiment, the first calculation module 402 includes:
a first calculation sub-module, configured to calculate the product of the mask matrix corresponding to the third sample set and a transposed matrix of the mask matrix;
and a first determination sub-module, configured to determine a difference value between a unit matrix and the product as a noise matrix corresponding to the third sample set.

In an optional embodiment, the first determination module 403 includes:
a second determination sub-module, configured to determine, from the first sample set, a first training sample having a corresponding relationship with a second training sample in the second sample set;
a third determination sub-module, configured to determine a current residual corresponding to the first training sample based on a linear predictor corresponding to the first training sample, a linear predictor corresponding to the second training sample, and a tag value corresponding to the first training sample, in which the linear predictor corresponding to the second training sample is determined by the second data party and sent to the first data party;
a fourth determination sub-module, configured to determine a residual vector corresponding to the first sample set based on the current residual corresponding to the first training sample;
and a fifth determination sub-module, configured to determine, from the residual vector corresponding to the first sample set, the residual vector corresponding to the third sample set.

In an optional embodiment, the third sample set is obtained, based on sample identifiers, by splitting the second sample set of the second data party.

In an optional embodiment, the third sample set includes at least one selected from a group consisting of a multimedia data training sample, an audio data training sample, a video data training sample, an image data training sample, and a text data training sample.

In the vertical federated learning apparatus provided by the embodiments of the present disclosure, by calculating a noise matrix for the second data party and encrypting the residual vector based on the noise matrix, it is ensured that the residual vector calculated by the first data party will not be acquired by the second data party, thereby achieving the purpose of protecting the privacy of tags in samples of the first data party. In addition, compared to the homomorphic encryption technique, the way of encrypting the residual vector by the noise matrix has less computational overhead, and thus the embodiments of the present disclosure are able to improve the efficiency of vertical federated learning while ensuring data privacy.

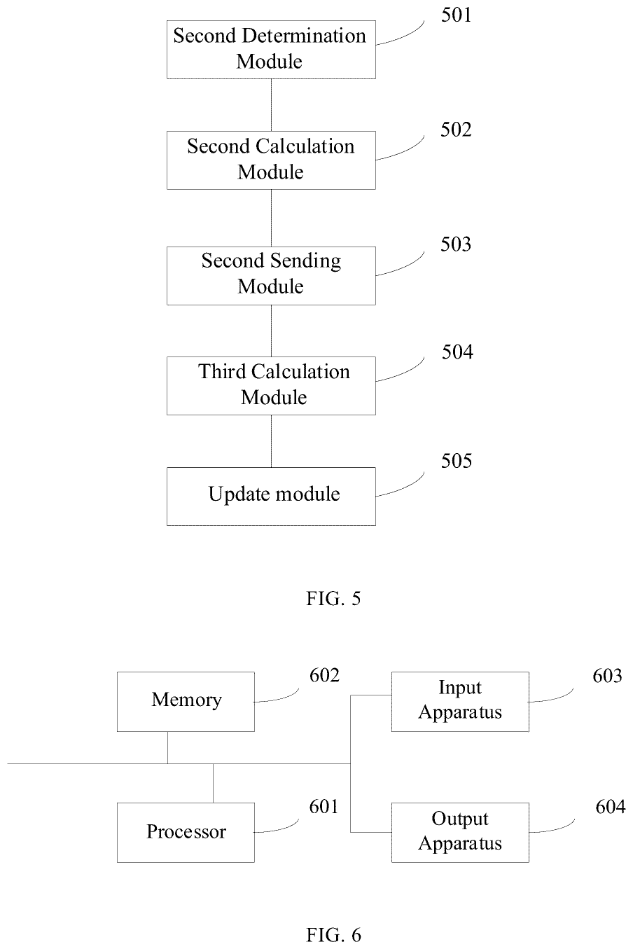

Based on the above-mentioned embodiments, the present disclosure further provides a vertical federated learning apparatus. With reference to FIG. 5, which shows a schematic diagram of a structure of another vertical federated learning apparatus according to an embodiment of the present disclosure, the apparatus includes:
a second determination module 501, configured to determine a third sample set based on a local second sample set;
a second calculation module 502, configured to calculate a mask matrix corresponding to the third sample set;
a second sending module 503, configured to send the mask matrix corresponding to the third sample set to a first data party in a vertical federated learning system, in which the first data party is used to determine a noise-added residual vector corresponding to the third sample set based on the mask matrix, a first sample set stored in the first data party includes a training sample with a tag, and the training sample with a tag in the first sample set has a corresponding relationship with a training sample in the second sample set;
a third calculation module 504, configured to acquire the noise-added residual vector from the first data party, and calculate a gradient vector based on the noise-added residual vector;
and an update module 505, configured to update a local model parameter based on the gradient vector to obtain an updated model parameter.

In an optional embodiment, the second determination module is specifically configured to:
splitting the local second sample set based on sample identifiers to obtain the third sample set.

In an optional embodiment, the second determination module includes:
a ranking sub-module, configured to rank training samples in the local second sample set based on the sample identifiers to obtain a ranked second sample set;
and a splitting sub-module, configured to split the ranked second sample set to obtain the third sample set.

In an optional embodiment, the second calculation module 502 includes:
a decomposition sub-module, configured to perform QR decomposition on a matrix corresponding to the third sample set to obtain a Q matrix and an R matrix, in which the product of the Q matrix and the R matrix is the matrix corresponding to the third sample set, and the Q matrix has the same number of rows and columns, which is equal to the number of rows of the matrix corresponding to the third sample set;
and an acquisition sub-module, configured to remove the first m columns of the Q matrix, and acquire g columns from the Q matrix to form the mask matrix corresponding to the third sample set, in which m is the number of columns of the matrix corresponding to the third sample set and g is a preset positive integer.

In the vertical federated learning apparatus provided by the embodiments of the present disclosure, the gradient vector is calculated based on the residual vector subjected to noise addition processing by means of the noise matrix, which consumes less system resources and can improve the efficiency of vertical federated learning while ensuring the data privacy.

In addition to the methods and apparatuses described above, the embodiments of the present disclosure further provide a computer-readable storage medium, the computer-readable storage medium stores instructions, and the instructions, when run on a terminal device, cause the terminal device to implement the vertical federated learning method described in the embodiments of the present disclosure.

The embodiments of the present disclosure further provide a computer program product including a computer program/instruction, and the computer program/instruction, when executed by a processor, implements the vertical federated learning method described in the embodiments of the present disclosure.

In addition, the embodiments of the present disclosure further provide a vertical federated learning device, referring to FIG. 6, which may include a processor 601, a memory 602, an input apparatus 603, and an output apparatus 604.

The number of the processor 601 in the vertical federated learning device may be one or more, and one processor is taken as an example in FIG. 6. In some embodiments of the present disclosure, the processor 601, the memory 602, the input apparatus 603 and the output apparatus 604 may be connected through a bus or other means, and the connection through the bus is taken as an example in FIG. 6.

The memory 602 can be configured to store software programs and modules, and the processor 601 executes various functional applications and data processing of the vertical federated learning device by running the software programs and modules stored in the memory 602. The memory 602 may mainly include a program storage area and a data storage area, and the program storage area may store an operating system, at least one application program required for a function, and the like. In addition, the memory 602 may include high-speed random-access memory, and may also include non-volatile memory, such as at least one magnetic disk storage device, flash memory device, or other volatile solid-state storage device. The input apparatus 603 may be configured to receive input numeric or character information, and to generate signal input related to user settings and function control of the vertical federated learning device.

Specifically, in the present embodiment, the processor 601 can follow the following instructions to load the executable files corresponding to the processes of one or more application programs into the memory 602, and the processor 601 can run the applications stored in the memory 602 to realize the various functions of the above-described vertical federated learning device.

It should be noted that in the present disclosure, relational terms such as “first,” “second,” etc. are only used to distinguish one entity or operation from another entity or operation, and do not necessarily require or imply the existence of any actual relationship or order between these entities or operations. Furthermore, the terms “comprise,” “comprising,” “include,” “including,” etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

The above descriptions are only specific embodiments of the present disclosure, enabling those skilled in the art to understand or implement the present disclosure. Various modifications to these embodiments will be readily apparent to those skilled in the art, and the generic principles defined herein may be practiced in other embodiments without departing from the spirit or scope of the present disclosure. Therefore, the present disclosure is not to be limited to the embodiments described herein but is to be accorded the widest scope consistent with the principles and novel features disclosed herein.

1. A vertical federated learning method, comprising:
receiving a mask matrix corresponding to a third sample set and sent by a second data party in a vertical federated learning system, wherein the third sample set is obtained based on splitting a second sample set of the second data party, and a training sample in the second sample set has a corresponding relationship with a training sample with a tag in a local first sample set;
calculating a noise matrix corresponding to the third sample set based on the mask matrix corresponding to the third sample set, wherein the noise matrix is composed of a quantity of noise corresponding to each training sample in the third sample set, and the quantity of noise is used for noise addition processing;
determining a residual vector corresponding to the third sample set, and determining a product of the residual vector and the noise matrix corresponding to the third sample set as a noise-added residual vector corresponding to the third sample set, wherein the residual vector comprises a difference value between a tag value and a current predicted value of a training sample in the third sample set; and
sending the noise-added residual vector corresponding to the third sample set to the second data party, wherein the second data party is used to calculate a gradient vector based on the noise-added residual vector, and to update a model parameter corresponding to the second data party based on the gradient vector to obtain an updated model parameter corresponding to the second data party.

2. The method according to claim 1, wherein calculating a noise matrix corresponding to the third sample set based on the mask matrix corresponding to the third sample set comprises:
calculating a product of the mask matrix corresponding to the third sample set and a transposed matrix of the mask matrix; and
determining a difference value between a unit matrix and the product of the mask matrix and the transposed matrix as the noise matrix corresponding to the third sample set.

3. The method according to claim 1, wherein determining a residual vector corresponding to the third sample set comprises:
determining, from the first sample set, a first training sample having a corresponding relationship with a second training sample in the second sample set;
determining a current residual corresponding to the first training sample based on a linear predictor corresponding to the first training sample, a linear predictor corresponding to the second training sample, and a tag value corresponding to the first training sample, wherein the linear predictor corresponding to the second training sample is determined by the second data party and sent to a first data party;
determining a residual vector corresponding to the first sample set based on the current residual corresponding to the first training sample; and
determining, from the residual vector corresponding to the first sample set, the residual vector corresponding to the third sample set.

4. The method according to claim 1, wherein the third sample set is obtained, based on sample identifiers, by splitting the second sample set of the second data party.

5. The method according to claim 1, wherein the third sample set comprises at least one selected from a group consisting of a multimedia data training sample, an audio data training sample, a video data training sample, an image data training sample, and a text data training sample.

6. A vertical federated learning method, comprising:
determining a third sample set based on a local second sample set, and calculating a mask matrix corresponding to the third sample set;
sending the mask matrix corresponding to the third sample set to a first data party in a vertical federated learning system, wherein the first data party is used to determine a noise-added residual vector corresponding to the third sample set based on the mask matrix, a first sample set stored in the first data party comprises a training sample with a tag, and the training sample with a tag in the first sample set has a corresponding relationship with a training sample in the second sample set;
acquiring the noise-added residual vector from the first data party, and calculating a gradient vector based on the noise-added residual vector; and
updating a local model parameter based on the gradient vector to obtain an updated model parameter.

7. The method according to claim 6, wherein determining a third sample set based on a local second sample set comprises:
splitting the local second sample set based on sample identifiers to obtain the third sample set.

8. The method according to claim 7, wherein splitting the local second sample set based on sample identifiers to obtain the third sample set comprises:
ranking training samples in the local second sample set based on the sample identifiers to obtain a ranked second sample set; and
splitting the ranked second sample set to obtain the third sample set.

9. The method according to claim 6, wherein calculating a mask matrix corresponding to the third sample set comprises:
performing QR decomposition on a matrix corresponding to the third sample set to obtain a Q matrix and an R matrix, wherein a product of the Q matrix and the R matrix is the matrix corresponding to the third sample set, and the Q matrix has a same number of rows and columns, which is equal to a total number of rows of the matrix corresponding to the third sample set; and
removing a first m columns of the Q matrix, and acquiring g columns from the Q matrix to form the mask matrix corresponding to the third sample set, wherein m is a total number of columns of the matrix corresponding to the third sample set and g is a preset positive integer.

10. A vertical federated learning system, comprising a first data party and at least one second data party, wherein a training sample with a tag in a first sample set of the first data party has a corresponding relationship with a training sample in a second sample set of the second data party;
the second data party is used to determine a third sample set based on the second sample set, calculate a mask matrix corresponding to the third sample set, and send the mask matrix corresponding to the third sample set to the first data party;
the first data party is used to calculate a noise matrix corresponding to the third sample set based on the mask matrix corresponding to the third sample set, determine a residual vector corresponding to the third sample set, determine a product of the residual vector and the noise matrix corresponding to the third sample set as a noise-added residual vector corresponding to the third sample set, and send the noise-added residual vector corresponding to the third sample set to the second data party, wherein the noise matrix is composed of a quantity of noise corresponding to each training sample in the third sample set, the quantity of noise is used for noise addition processing, the residual vector comprises a difference value between a tag value and a current predicted value of a training sample in the third sample set; and
the second data party is further used to calculate a gradient vector based on the noise-added residual vector, and to update a local model parameter based on the gradient vector to obtain an updated model parameter corresponding to the second data party.

11-12. (canceled)

13. A computer-readable storage medium, storing instructions, wherein the instructions, when run on a terminal device, cause the terminal device to implement the method of claim 1.

14. A vertical federated learning device, comprising a memory, a processor, and a computer program stored on the memory and runnable on the processor, wherein the processor, when executing the computer program, implements the method of claim 1.

15. (canceled)

16. The method according to claim 2, wherein the third sample set is obtained, based on sample identifiers, by splitting the second sample set of the second data party.

17. The method according to claim 3, wherein the third sample set is obtained, based on sample identifiers, by splitting the second sample set of the second data party.

18. The method according to claim 7, wherein calculating a mask matrix corresponding to the third sample set comprises:
performing QR decomposition on a matrix corresponding to the third sample set to obtain a Q matrix and an R matrix, wherein a product of the Q matrix and the R matrix is the matrix corresponding to the third sample set, and the Q matrix has a same number of rows and columns, which is equal to a total number of rows of the matrix corresponding to the third sample set; and
removing a first m columns of the Q matrix, and acquiring g columns from the Q matrix to form the mask matrix corresponding to the third sample set, wherein m is a total number of columns of the matrix corresponding to the third sample set and g is a preset positive integer.

19. The method according to claim 8, wherein calculating a mask matrix corresponding to the third sample set comprises:
performing QR decomposition on a matrix corresponding to the third sample set to obtain a Q matrix and an R matrix, wherein a product of the Q matrix and the R matrix is the matrix corresponding to the third sample set, and the Q matrix has a same number of rows and columns, which is equal to a total number of rows of the matrix corresponding to the third sample set; and
removing a first m columns of the Q matrix, and acquiring g columns from the Q matrix to form the mask matrix corresponding to the third sample set, wherein m is a total number of columns of the matrix corresponding to the third sample set and g is a preset positive integer.

20. A computer-readable storage medium, storing instructions, wherein the instructions, when run on a terminal device, cause the terminal device to implement the method of claim 2.

21. A computer-readable storage medium, storing instructions, wherein the instructions, when run on a terminal device, cause the terminal device to implement the method of claim 3.

22. A vertical federated learning device, comprising a memory, a processor, and a computer program stored on the memory and runnable on the processor, wherein the processor, when executing the computer program, implements the method of claim 2.

23. A vertical federated learning device, comprising a memory, a processor, and a computer program stored on the memory and runnable on the processor, wherein the processor, when executing the computer program, implements the method of claim 3.
